(19) United States
(12) Patent Application Publication
(10) Pub. No.: US 2025/0229909 A1
(43) Pub. Date: Jul. 17, 2025

(54) THERMAL ASSEMBLY FOR A PROPULSION SYSTEM OF AN AIRCRAFT

(71) Applicant: Airbus Operations SAS, TOULOUSE (FR)

(72) Inventors: Szymon FULARA, TOULOUSE (FR); Sébastien DARGEIN, TOULOUSE (FR)

(21) Appl. No.: 19/013,408

(22) Filed: Jan. 8, 2025

(30) Foreign Application Priority Data
Jan. 11, 2024 (FR) 2400262

(51) Int. Cl. B64D 33/10

(52) U.S. Cl. CPC B64D 33/10

(57) ABSTRACT

A thermal assembly including a heat exchanger including a central matrix including a first assembly, an inlet module configured to cause a first fluid to enter the central matrix, and an outlet module configured to evacuate the first fluid from the central matrix, and a support including a base to be fixed to the propulsion system and rails rigidly fastened to the base including a second assembly cooperating with the first assembly to form a sliding connection. Also an aircraft with such a heat exchanger.

### CROSS-REFERENCES TO RELATED APPLICATIONS

This application claims the benefit of French Patent Application Number 2400262 filed on Jan. 11, 2024, the entire disclosure of which is incorporated herein by way of reference.

### FIELD OF THE INVENTION

The present invention concerns a thermal assembly for a propulsion system of an aircraft as well as an aircraft including a propulsion system and such a thermal assembly coupled to the propulsion system.

### BACKGROUND OF THE INVENTION

In an aircraft a heat exchanger, for example of the air-oil type, is usually employed to cool the oil of a propulsion system of the aircraft using incoming cold air. For example, in one particular configuration the incoming cold air can be bled from the secondary flow of the turbine of the propulsion system.

As depicted in FIG. 2, a prior art air-oil thermal assembly 9 includes a heat exchanger 90 including a matrix 92 enabling an exchange of heat, primarily by conduction and convection, between the oil of the propulsion system that circulates in the matrix 92 and cold air, an air inlet 91 enabling efficient entry of cold air into the matrix 92 and an air outlet 93 enabling evacuation of the air out of the matrix 92.

Such a thermal assembly 9 is assembled with the aid of hooks 94 and bolts on the casing of the propulsion system (not depicted). The hooks 94 connect the inlet 91, the matrix 92 and the outlet 93 directly to the casing of the propulsion system. Bolted flanges between the inlet 91, the matrix 92 and the outlet 93 clamp the elements together and seal them. Although the present solution is efficient for cooling the oil of the propulsion system, a disadvantage of this way of assembling the thermal assembly is that when replacing an element 91, 92, 93, in particular the matrix 92, is necessary, the hooks 94 must be demounted and these demounting and remounting operations are time-consuming and therefore costly.

Thus there exists a need to provide a new solution for facilitating the assembly of the elements of the thermal assembly while providing a good seal between those elements.

### SUMMARY OF THE INVENTION

An object of the present invention is to propose a thermal assembly for a propulsion system of an aircraft that enables easy mounting and demounting of a heat exchanger to be fixed to the propulsion system of the aircraft.

To this end there is proposed a thermal assembly for a propulsion system of an aircraft, said thermal assembly including:
a heat exchanger including a central matrix including first assembly means, an inlet module configured to cause a first fluid to enter the central matrix and an outlet module configured to evacuate the first fluid from the central matrix, where said central matrix is in fluidic connection with said inlet module and said outlet module, and
a support including a base intended to be fixed to the propulsion system and rails rigidly fastened to the base including second assembly means cooperating with said first assembly means to form a sliding connection.

With such an assembly it is possible to assemble the central matrix onto the support simply and rapidly by simply sliding the central matrix in the support.

The operations of mounting and demounting the central matrix and more generally the heat exchanger are therefore facilitated.

In accordance with one particular aspect said rails include third assembly means and said inlet module includes fourth assembly means and/or said outlet module includes fifth assembly means. Said third assembly means of said rails cooperate with the fourth assembly means and/or with the fifth assembly means to form sliding connections.

In accordance with another particular aspect said second assembly means, when present, and said third assembly means of said rails include a groove or a rib. Said first assembly means and, when present, the fourth assembly means and the fifth assembly means respectively include a rib received in said groove or a groove receiving said rib.

In accordance with a further particular aspect the thermal assembly includes first sealing means disposed between said first assembly means of said central matrix and said second assembly means of the rails and, when present, between said third assembly means and the fourth assembly means or the fifth assembly means.

In accordance with one particular aspect said central matrix includes first abutments and second abutments. Said inlet module includes for each first abutment a first counter-abutment that is abutted against said first abutment, and said outlet module includes for each second abutment a second counter-abutment that is abutted against said second abutment.

In accordance with another particular aspect the thermal assembly includes second sealing means disposed between each abutment and the associated counter-abutment.

In accordance with another particular aspect the thermal assembly includes first fixing means that fix said inlet module to rails of said support and second fixing means that fix said outlet module to rails of said support.

In accordance with one particular aspect said rails extend globally perpendicularly to said base.

In accordance with another particular aspect said rails extend globally parallel to said base.

The invention also proposes an aircraft including a propulsion system and a thermal assembly as described above wherein the base is fixed to the propulsion system.

### BRIEF DESCRIPTION OF THE DRAWINGS

The features of the invention mentioned hereinabove and others will become more clearly apparent on reading the following description of one embodiment given with reference to the appended drawings in which:

FIG. 1 is a side view of an aircraft according to the invention;

FIG. 2 is a perspective view of a prior art thermal assembly;

FIG. 3 is an exploded perspective view depicting a thermal assembly conforming to one embodiment of the invention;

FIG. 4 is a perspective view depicting a thermal assembly conforming to the FIG. 3 embodiment during a phase of assembling it with a main support;

FIG. 5 is a view from above schematically depicting assembly means of the thermal assembly from FIG. 3;

FIG. 6 is a side view schematically depicting sealing means employed between the modules of the heat exchanger from the assembly from FIG. 3; and

FIG. 7 is an exploded perspective view depicting a thermal assembly conforming to a variant of the FIG. 3 embodiment of the invention.

### DETAILED DESCRIPTION OF THE PREFERRED EMBODIMENTS

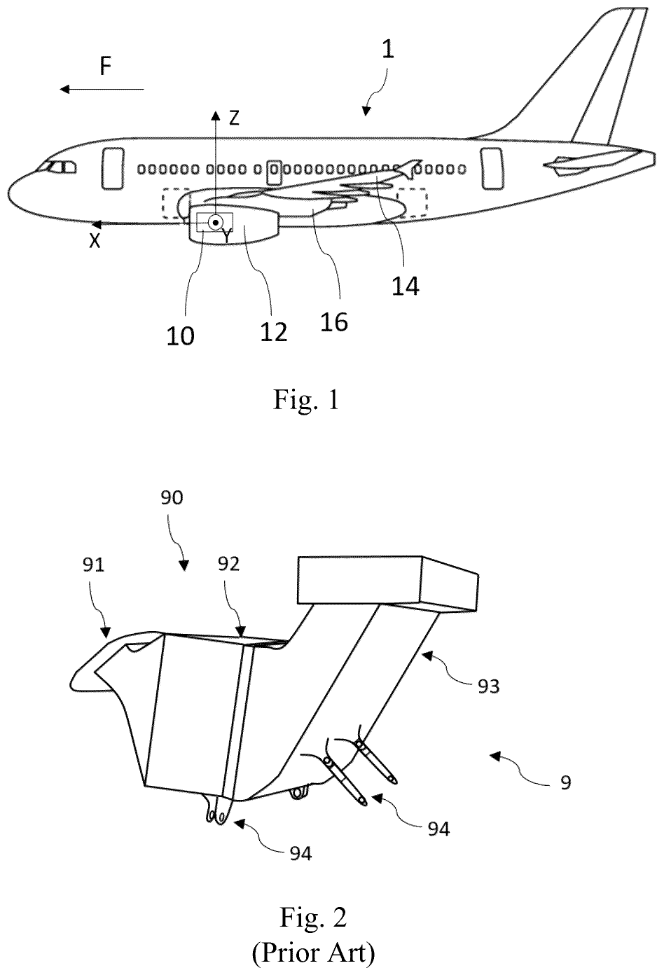

FIG. 1 shows an aircraft 1 that includes a propulsion system 12, for example of the turbojet or turboprop type. The propulsion system 12 is connected to a wing 14 of the aircraft 1 via an engine pylon 16.

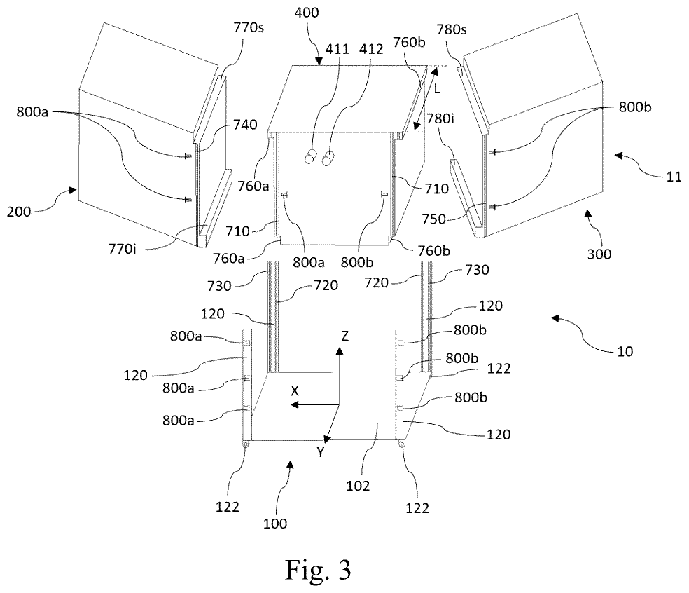

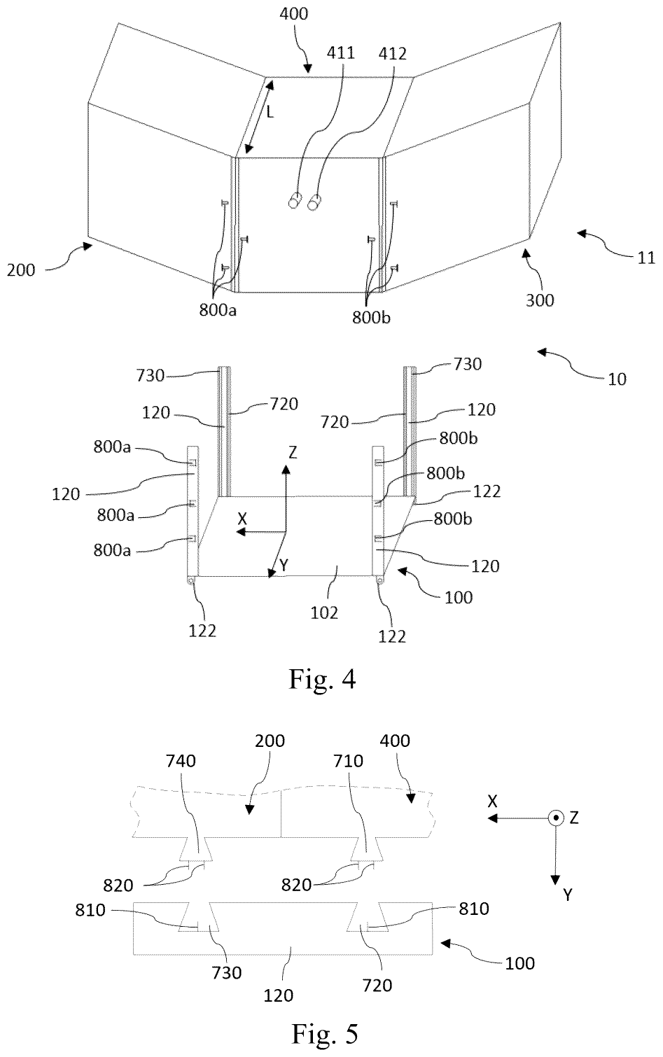

The aircraft 1 also includes a thermal assembly 10 according to the invention that is coupled to the propulsion system 12. FIGS. 3 and 4 show the thermal assembly 10 conforming to one embodiment of the invention and FIG. 7 shows a variant embodiment of the invention.

The thermal assembly 10 includes a heat exchanger 11 rigidly fastened to a support 100 fixed to the propulsion system 12.

In the following description terms relating to a position refer to an aircraft in the normal flight position, that is to say as represented in FIG. 1, and “front” and “rear” positions are relative to the front and the rear of the propulsion system 12 and relative to the direction F of forward movement of the aircraft 1 when the propulsion system 12 is functioning.

In the following description, and by convention, X denotes the longitudinal direction of the propulsion system, which is horizontal when the aircraft is on the ground, Y denotes the transverse direction, which is horizontal when the aircraft is on the ground, and Z denotes the vertical direction when the aircraft is on the ground, these three directions X, Y and Z being mutually orthogonal.

Here the heat exchanger 11 and the support 100 have a vertical median plane XZ.

The thermal assembly 10 includes a heat exchanger 11 through which passes a first fluid that has the function of cooling or heating a second fluid circulating in the heat exchanger 11. In this example the second fluid is a fluid circulating in the propulsion system 12 and in particular oil. It is nevertheless understood that other fluids could complement or be substituted for the fluid circulating in the propulsion system 12 to circulate in the heat exchanger 11 in order to be cooled or heated.

The heat exchanger 11 includes a central matrix 400 including first assembly means 710, an inlet module 200 configured to cause the first fluid, also known as the exchange fluid, to enter the central matrix 400 and an outlet module 300 configured to evacuate the first fluid from the central matrix 400.

The central matrix 400 enables thermal exchanges, in other words exchanges of heat, between the second fluid and the first fluid (for example air, and in particular cold air generally bled from the secondary flow of the turbine of the propulsion system 12). The thermal exchanges in the central matrix 400 are effected primarily by conduction and convection.

The central matrix 400 is in fluidic connection with the inlet module 200 and the outlet module 300 to provide circulation without leaks of the first fluid successively through the inlet module 200, the central matrix 400 and the outlet module 300 of the heat exchanger 11. The heat exchanger 11 and to be more precise the central matrix 400 is furthermore in fluidic communication with the circuit for the second fluid. In this example the matrix 400 is in fluidic communication with the fluid circuit of the propulsion system 12 by way of a first connector 411 through which the second fluid enters the heat exchanger 11 and a second connector 412 through which the second fluid exits the heat exchanger 11 after thermal exchanges have taken place in the central matrix 400. For example, the first connector 411 and the second connector 412 are of the quick connect/disconnect type.

In order in particular to limit the length of the pipes conveying the second fluid, such a heat exchanger 11 is preferably fixed to a casing of the propulsion system 12. To this end the heat exchanger 11 includes a support 100 including a base 102 intended to be fixed to the propulsion system 12 and rails 120 rigidly fastened to the base 102. The rails 120 include second assembly means 720 cooperating with the first assembly means 710 to form a sliding connection in an assembly direction that here is parallel to the vertical direction Z.

The thermal assembly 10 according to the invention therefore enables simple and rapid assembly of the central matrix 400 onto the support 100 fixed to the propulsion system 12. More specifically, the central matrix 400 can be fixed to the support 100 simply by sliding the central matrix 400 in the support 100 thanks to the first assembly means 710 and the second assembly means 720 forming a sliding connection.

The operations of mounting and where necessary replacing the central matrix 400 of the heat exchanger 11 are therefore facilitated. The present solution therefore makes it possible to dispense with demounting/withdrawing the whole of the heat exchanger 11 from the propulsion system 12 because the support 100 can remain fixed to the propulsion system 12, which facilitates use and saves a considerable amount of time.

In the example depicted the support 100 includes means 122 for coupling the support 100 to the propulsion system 12. Here the coupling means 122 take the form of protrusions projecting from the base 102 in the direction of the propulsion system 12. More specifically, here the base 102 extends in a plane globally parallel to the horizontal plane XY. Here the protrusions 122 extend in a direction globally perpendicular to the plane of the base 102, that is to say in a direction globally parallel to the vertical direction Z. Each protrusion 122 includes a hole enabling a fixing rod such as a bolt or a rivet cooperating with the casing of the propulsion system 12, for example, to pass through it. Thus the support 100 is fixed to the propulsion system 12 by its base 102. In this example the base 102 has a quadrilateral shape and a protrusion 122 is disposed at each corner of the base 102 to ensure optimum coupling of the support 100 to the propulsion system 12 of the aircraft 1. The coupling means 122 are preferably situated at the edges of the base 102 in order to optimize their accessibility.

In accordance with one particular aspect the rails 120 include third assembly means 730. Furthermore, the inlet module 200 includes fourth assembly means 740. Additionally or instead the outlet module 300 may equally well include fifth assembly means 750. Thus, when present, the third assembly means 730 of the rails 120 cooperate with the fourth assembly means 740 and/or the fifth assembly means 750 to form sliding connections in the assembly direction.

In this way the thermal assembly 10 according to the invention enables simple and rapid assembly of the inlet module 200 and the outlet module 300 onto the support 100. Indirectly, the assembly means 710, 720, 730, 740 and 750 together make it possible, via the support 100, to assemble the modules 200 and 300 onto the central matrix 400. These assembly means 710, 720, 730, 740 and 750 therefore make it possible to facilitate the operations of assembling the thermal assembly 10 and where necessary to facilitate the operations of replacing one or more modules of the heat exchanger 11.

Such a thermal assembly 10 may furthermore be of modular design and if necessary makes it possible to interchange the inlet module 200 and the outlet module 300 depending in particular on the configuration and the positioning of the propulsion system 12. This also makes it possible if required to replace the inlet module 200 and the outlet module 300 by modules of different shape adapted in particular to suit the constraints on and the configuration of the propulsion system 12.

In this example the inlet module 200 and the outlet module 300 both include assembly means for the fourth assembly means 740 and the fifth assembly means 750 respectively. It is nevertheless understood that the inlet module 200 or the outlet module 300 need not employ such assembly means.

In accordance with one particular aspect the second assembly means 720 and, when present, the third assembly means 730 of the rails 120 include a groove or a rib.

Correspondingly, the first assembly means 710 of the central matrix 400 and, when present, the fourth assembly means 740 and the fifth assembly means 750 of the inlet module 200 and the outlet module 300, respectively, include a rib received in the groove or a groove receiving the rib.

In the FIG. 5 example depicting a rail 120 as seen from above before the central matrix 400 and the inlet module 200 are mounted the second assembly means 720 and the third assembly means 730 carried by the rails 120 include a groove. The first assembly means 710 of the central matrix 400 and the fourth assembly means 740 of the inlet module 200 each include a rib received in the groove of the corresponding second assembly means 720 and the third assembly means 730. Although the outlet module 300 is not depicted in this figure, it is clear that the fifth assembly means 750 of the outlet module 300, when present, may equally well include a rib received in the groove of the corresponding third assembly means 730 carried by the rail 120 of the support 100.

Such assembly means enable simple, rapid and reliable assembly of the inlet module 200, the outlet module 300 and the central matrix 400 onto the support 100. In fact, it suffices to cause the modules 200 and 300 as well as the central matrix 400 to slide in the rails 120 of the support 100, i.e., to move them in translation in the assembly direction, to fix them to the latter.

Such a heat exchanger 11 is furthermore easy to make modular because it makes it possible, if required, to add intermediate modules or inlet modules 200 and outlet modules 300 of different shapes for example on the rails of the support 100.

In the example depicted the grooves and the ribs have a dovetail shape so as to ensure optimum guiding of the modules 200, 300 and the central matrix 400 in the rails 120. Furthermore, such a groove and rib shape enables retention of the modules 200, 300 and the central matrix 400 in the rails 120. It is nevertheless understood that other shapes, such as a T-shape for example, can be envisaged without departing from the general principle of the invention.

Referring to the FIG. 5 orientation, the central matrix 400 slides in the support 100 in the assembly direction parallel to the vertical direction Z toward the base 102 of the support. The same applies to the inlet module 200 (depicted) and the outlet module 300 (not depicted). As indicated above the dovetail shape employed here also enables the modules 200, 300 and the central matrix 400 to be retained in the rails 120. In fact, the shape of the grooves and the ribs prevents movement of the central matrix 400, the inlet module 200 and the outlet module 300 in the longitudinal direction X.

In accordance with one particular aspect the heat exchanger 11 optionally includes first sealing means 810, 820 disposed between the first assembly means 710 of the central matrix 400 and the second assembly means 720 of the rails 120 and, when present, between the third assembly means 730 and the fourth assembly means 740 or the fifth assembly means 750.

In this way the first sealing means 810, 820 enable a seal to be made between the central matrix 400 and the support 100. The first sealing means also enable a seal to be made between the support 100 and the inlet module 200 and/or the outlet module 300. The risks of the first fluid leaking are therefore prevented so as to optimize the performance of the heat exchanger 11.

As depicted for example in FIG. 5 the first sealing means 810, 820 take the form of sealing teeth, for example made of rubber, that extend globally perpendicularly to the longitudinal axis of the grooves and the ribs. The sealing teeth of the rails 120 extend toward the central matrix 400 and the inlet module 200 and the outlet module 300 whereas the sealing teeth of the central matrix 400 and the inlet module 200 and the outlet module 300 extend toward the rails 120.

Each groove preferably includes a sealing tooth and each groove preferably includes two sealing teeth (or vice versa) spaced from one another and between which the sealing tooth of the groove is received. In this way the sealing teeth form a labyrinth preventing the fluid from passing through the junction between the rails 120 and the modules of the heat exchanger 11 to provide an optimum seal.

The sealing teeth therefore make it possible to seal the junction between the rails 120 and the central matrix 400 and between the rails 120 and the inlet module 200 and the outlet module 300.

The use of rubber sealing teeth also makes it possible to reduce vibrations between the heat exchanger 11 and the support 100 and between the modules 200, 300 and 400 of the heat exchanger 11.

In accordance with one particular aspect the central matrix 400 includes first abutments 760a and second abutments 760b. The inlet module 200 includes for each first abutment 760a a first counter-abutment 770s, 770i that is abutted against the first abutment 760a of the central matrix 400. In the same way, the outlet module 300 includes for each second abutment 760b a second counter-abutment 780s, 780i that is abutted against the second abutment 760b of the central matrix 400.

Positioning the inlet module 200 and the outlet module 300 against the central matrix 400 is therefore simple and rapid. Furthermore, the inlet module 200 and the outlet module 300 are therefore retained in position relative to the central matrix 400.

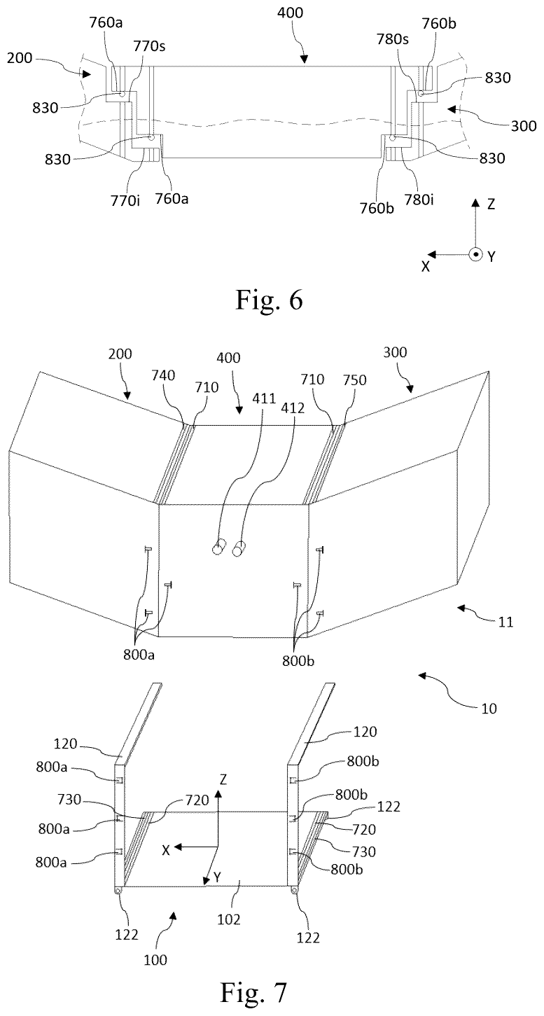

To be more precise, and as depicted in FIG. 6, the first abutments 760a and the second abutments 760b of said central matrix 400 include a rim or a depression. In this example the central matrix 400 includes a rim for the abutments 760a and 760b in the upper part of the central matrix 400 and a depression for the abutments 760a and 760b in the lower part of the central matrix 400.

Correspondingly, the inlet module 200 includes a first counter-abutment 770s in the form of a depression in the upper part of the inlet module 200 that comes to abut against the first abutment 760a and in the form of a rim. The inlet module 200 further includes a first counter-abutment 770i in the form of a rim in the lower part of the inlet module 200 that comes to abut against the first abutment 760s in the form of a depression.

Similarly, the outlet module 300 includes a second counter-abutment 780s in the form of a depression in the upper part of the outlet module 300 that comes to abut against the first abutment 760a in the form of a rim. The outlet module 300 further includes a second counter-abutment 780i in the form of a rim in the lower part of the outlet module 300 that comes to abut against the first abutment 760a in the form of a depression.

As depicted, here the first abutment 760a and the second abutment 760b therefore come to abut against the first counter-abutments 770i and 770s and the second counter-abutments 780i and 780s to prevent movement of the inlet module 200 and the outlet module 300, here in the vertical direction Z.

To assemble the heat exchanger 11 onto the support 100 there may be envisaged first of all assembling the inlet module 200 and the outlet module 300 onto the support 100 by moving them toward the base 102 on the support 100. The inlet module 200 and the outlet module 300 are moved parallel to the assembly direction, here parallel to the opposite sense of the vertical direction Z, so that the third assembly means 730 cooperate with the fourth assembly means 740 and the fifth assembly means 750. The central matrix 400 can then be assembled onto the support 100 by moving the central matrix 400 in the direction of the base 102 of the support 100 parallel to the assembly direction, here parallel to the opposite sense of the vertical direction Z, so that the first assembly means 710 cooperate with the second assembly means 720.

In accordance with one particular aspect the thermal assembly 10 optionally includes second sealing means 830 disposed between each abutment 760a, 760b and the associated counter-abutment 770s, 770i and 780s, 780i.

To be more precise, the second sealing means 830 take the form of a seal disposed against the first abutments 760a and 760b. The seal extends globally over the whole of the length L of the first abutments 760a, 760b of the central matrix 400. Respective seals are therefore disposed between the central matrix 400 and the inlet module 200 and between the central matrix 400 and the inlet module 300.

Such second sealing means 830 therefore make it possible to seal the junction between the central matrix 400, the inlet module 200 and the outlet module 300.

The use of this seal, which is made of rubber for example, also makes it possible to reduce vibrations between the modules 200, 300 and 400 of the heat exchanger 11.

In accordance with another aspect the heat exchanger 11 includes first fixing means 800a for fixing the inlet module 200 to rails 120 of the support 100 and second fixing means 800b for fixing the outlet module 300 to rails of the main support 100.

Such fixing means enable immobilization of the inlet module 200 and the outlet module 300 relative to the rails 120 of the support 100. To be more specific, these fixing means 800a, 800b prevent movement of the modules 200 and 300 in the directions X, Y and Z.

For example, the first fixing means 800a and the second fixing means 800b are of the aircraft latch type, used in particular to lock engine cowlings.

According to one particular aspect the rails 120 extend globally perpendicularly to the base 102.

Thus the heat exchanger 11 is rigidly fastened to the support 100 by movement in translation of the heat exchanger 11 in the rails 120. In the example depicted in FIGS. 3 and 4 this movement in translation is effected in a direction parallel to and in the opposite sense of the vertical direction Z. In other words, the insertion and the withdrawal of the heat exchanger 11 in and from the support 100 are effected transversely to the base 102, which means that the insertion and the withdrawal of the heat exchanger 11 in and from the support 100 are effected in a direction transverse to the longitudinal direction X of the propulsion system 12 and more generally a radial direction relative to the propulsion system 12.

In a variant embodiment shown in FIG. 7 the rails 120 extend globally parallel to the base 102. In this case the rails 120 are the shape of a “C” with the base at the bottom of the “C” fixed to the base 102 of the support 100. Furthermore, the base of the “C” extends globally parallel to the base 102.

In this example the first fixing means 800a and the second fixing means 800b are disposed on the upright of the “C” extending parallel to the vertical axis Z. It is nevertheless readily understandable that disposing the first fixing means 800a and the second fixing means 800b in some other manner, in particular depending on the position of the thermal assembly 10 on the propulsion system 12 and/or the configuration of the thermal assembly 10, may be envisaged. For example, the first fixing means 800a and the second fixing means 800b may be disposed on the upright of the “C” carrying the rails 120.

As before, the heat exchanger 11 is rigidly fastened to the support 100 by movement in translation of the heat exchanger 11 in the rails 120. As depicted in FIG. 7, the movement in translation of the heat exchanger 11 is in this example effected in a direction parallel to the horizontal transverse direction Y and more generally in a direction ortho-radial to the propulsion system 12.

The thermal assembly 10 according to the invention can therefore be adapted to suit any configuration of the propulsion system 12 so as to address all constraints that may be encountered when installing the thermal assembly 10.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A thermal assembly for a propulsion system of an aircraft, said thermal assembly including:
a heat exchanger including a central matrix including first assembly means, an inlet module configured to cause a first fluid to enter the central matrix and an outlet module configured to evacuate the first fluid from the central matrix, where said central matrix is in fluidic connection with said inlet module and said outlet module, and
a support including a base configured to be fixed to the propulsion system and rails rigidly fastened to the base including second assembly means cooperating with said first assembly means to form a sliding connection,
wherein said rails include third assembly means,
wherein said inlet module includes fourth assembly means, or said outlet module includes fifth assembly means, or both,
wherein said third assembly means of said rails cooperate with the fourth assembly means, with the fifth assembly means, or both to form sliding connections.

2. The thermal assembly as claimed in claim 1, wherein said second assembly means and said third assembly means of said rails include a groove or a rib, and
wherein said first assembly means and, when present, the fourth assembly means and the fifth assembly means respectively include a rib received in said groove or a groove receiving said rib.

3. The thermal assembly as claimed claim 1, further comprising first sealing means disposed between said first assembly means of said central matrix and said second assembly means of the rails and, when present, between said third assembly means and the fourth assembly means or the fifth assembly means.

4. The thermal assembly as claimed in claim 1, wherein said central matrix includes first abutments and second abutments,
wherein said inlet module includes, for each first abutment, a first counter-abutment that is abutted against said first abutment, and
wherein that said outlet module includes, for each second abutment, a second counter-abutment that is abutted against said second abutment.

5. The thermal assembly as claimed in claim 4, further comprising second sealing means disposed between each abutment and the respective counter-abutment.

6. The thermal assembly as claimed in claim 1, further comprising first fixing means for fixing said inlet module to rails of said support and second fixing means for fixing said outlet module to rails of said support.

7. The thermal assembly as claimed in claim 1, wherein said rails extend globally perpendicularly to said base.

8. The thermal assembly as claimed in claim 1, wherein said rails extend globally parallel to said base.

9. An aircraft comprising:
a propulsion system, and
the thermal assembly as claimed in claim 1, wherein the base is fixed to the propulsion system.
